(19) United States
(12) Patent Application Publication
(10) Pub. No.: US 2013/0060521 A1
(43) Pub. Date: Mar. 7, 2013

(54) DISPLACEMENT SENSOR AND METHOD FOR DETECTING DISPLACEMENT

(71) Applicant: Tetsuya Shimizu, Kyoto-shi (JP)

(72) Inventor: Tetsuya Shimizu, Kyoto-shi (JP)

(21) Appl. No.: 13/639,421

(22) PCT Filed: Feb. 4, 2011
(86) PCT No.: PCT/JP2011/052334

§ 371 Date: Oct. 4, 2012

(30) Foreign Application Priority Data
Apr. 12, 2010 (JP) 2010-091105

(51) Int. Cl. G01B 7/14; G06F 15/00

(52) U.S. Cl. 702/155

(57) ABSTRACT

A displacement sensor outputs displacement without delay caused by the detection period of the displacement sensor, when output of displacement is requested from outside. Displacement is detected using a phase difference between an input signal waveform and an output signal waveform. A detection time is derived by a timer when the sensor detects a displacement, and at least two previous detected displacements are stored together with detection times thereof. When output is requested from outside, the two previous displacements are extrapolated to a current displacement, based on the two previous displacements and detection times and a time at which output was requested, and the current displacement is output.

### BACKGROUND OF THE INVENTION

1. Field of the Invention

The present invention relates to a displacement sensor that detects displacement of mobile bodies such as machine tool heads, workpieces, transfer devices and transport vehicles, and to a displacement detection method.

2. Description of the Related Art

The inventors have developed displacement sensors for measuring displacement of machine tool heads, transfer devices, transport devices, transport vehicles and the like. See, for example, JP 2003-139563A and JP 2009-2660A. In JP 2003-139563A, a plurality of marks are provided along a shaft of an adsorption type transport device or the like, by providing magnetic portions and nonmagnetic portions alternately on the shaft, with one magnetic portion and one nonmagnetic portion serving as one mark. An alternating current is applied as an input signal to primary coils consisting of four coils, for example. When a phase difference between the input alternating current and an output signal from four secondary coils, for example, disposed in parallel with the primary coils is derived, the phase difference represents displacement based on the marks. In JP 2009-2660A, rather than distinguishing between primary coils and secondary coils, an alternating current is applied as a primary-side signal to a coil array consisting of coils connected in series, and a potential of a connection point between the coils is taken as a secondary-side signal. Mark-based displacement (position of mobile body) is similarly derived from the phase difference between the primary-side signal and the secondary-side signal.

JP 2009-2660A gives a detailed description of phase difference detection. When the waveform of the alternating current is given as sin ωt, two signals a·cos θ·sin ωt and a·sin θ·sin ωt are taken from the coils, θ being the phase difference and indicating a relative position in relation to the marks in a range of 0 to 2π. When the phase of the signal a·sin θ·sin ωt is advanced 90 degrees to a·sin θ·cos ωt and added to a·cos θ·sin ωt, a signal a·sin(0+ωt) is obtained from the additional theorem. The counter is reset at the point in time that the input signal sin ωt crosses zero, and θ is obtained when the counter is latched at the point in time that the signal a·sin(0+ωt) crosses zero, with θ representing the displacement. In the case where the signal a·sin(0+ωt) crosses zero first, a time lag until the signal sin ωt subsequently crosses zero is derived.

Because θ is derived by zero crossing, as described above, displacement is only derived once or twice during one period of the input AC signal. Even in the case where zero crossing is not used, the detection frequency per period is limited since phase difference is detected. The fact that the frequency with which displacement is derived per unit time is limited causes problems with movement of a machine tool head or workpieces, transfer of goods, control of a transport device or a transport vehicle, and the like. With these systems, a servo system for movement of a head, travel of a transport device or the like receives displacements from a displacement sensor, and performs control based on a target displacement, that is, error from a target position. For this reason, displacement needs to be derived within a short time period, and in particular needs to be derived in accordance with the control period of the servo system rather than being derived periodically to suit the displacement sensor.

### SUMMARY OF THE INVENTION

Preferred embodiments of the present invention enable displacement to be output without delay caused by a detection period of a displacement sensor, when output of displacement is requested from outside.

Other preferred embodiments of the present invention enable displacement to be output more quickly, and, in particular, without delay caused by arithmetic operations.

According to a preferred embodiment of the present invention, a displacement sensor that detects displacement using a phase difference between an input signal waveform and an output signal waveform, in order to output, in response to a request from a servo system to generate an instruction to eliminate an error between a current position and a target position by comparing a current position and a target position every control period, the current position to the servo system, includes a timer that outputs a detection time when the sensor detects a displacement, a memory that stores at least two previous detected displacements together with detection times thereof, and an operation unit that extrapolates, when an output is requested from servo system, the at least two previous displacements to a current displacement, based on the at least two previous displacements and detection times and a time at which output was requested, and outputs the current displacement, the memory further storing (Di−Di−1)/(ti−ti−1), the operation unit being configured to derive a displacement at time r+τ as a current displacement Dr by Dr=Di+(r+τ−ti)×(Di−Di−1)/(ti−ti−1) using the value of (Di−Di−1)/(ti−ti−1) stored in the memory, and output the current displacement Dr to the servo system as the current position, where Di and Di−1 are the two previous displacements, ti and ti·1 are the two previous detection times, r is the time at which output was requested, Dr is the current displacement, and τ is an operation delay in the operation unit.

According to another preferred embodiment of the present invention, a method for detecting displacement with a displacement sensor, using a phase difference between an input signal waveform and an output signal waveform, in response to a request from a servo system to generate an instruction to eliminate an error between a current position and a target position, by comparing a current position and a target position every control period, in order to output the current position to the servo system, includes the steps of deriving a detection time using a timer when the sensor detects a displacement; storing at least two previous detected displacements in a memory together with detection times thereof; and extrapolating, when output is requested from the servo system, the at least two previous displacements to a current displacement, based on the at least two previous displacements and detection times and a time at which output was requested, and outputting the current displacement, using an operation unit, the memory further storing (Di−Di−1)/(ti−ti−1), and the operation unit deriving a displacement at time r+τ as a current displacement Dr by Dr=Di+(r+τ−ti)×(Di−Di−1)/(ti−ti−1) using the value of (Di−Di−1)/(ti−ti−1) stored in the memory, and outputting the current displacement Dr to the servo system as the current position, where Di and Di−1 are the two previous displacements, ti and ti−1 are the two previous detection times, r is the time at which output was requested, Dr is the current displacement, and τ is an operation delay in the operation unit.

With a displacement sensor that detects displacement using the phase difference between an input signal waveform and an output signal waveform, the use of the phase difference indicates that displacement is only detected once, for example, per input signal period. In contrast, with an external servo system or the like that performs control with the signal of the displacement sensor, the current position is required at a timing that depends on the control period in the servo system, and, moreover, the control period is generally shorter than the period in the displacement sensor. In view of this, rather than shortening the detection period of the displacement sensor or constantly interpolating the current position within the displacement sensor, the receipt of a request for output from outside is used as a trigger, and the current displacement is derived through extrapolation based on two previous displacements and detection times and the time at which output was requested, and output. This enables displacement to be output in real time in response to a request from the external servo system. Also, the detection period of the displacement sensor does not need to be shortened, and because the current displacement is not constantly being derived through extrapolation and output when requested, extrapolation may also be performed with simple circuitry.

As a basis of a preferred embodiment of the present invention, the operation unit may preferably calculate the current displacement by Dr=Di+(Di−Di−1)×(r−ti)/(ti−ti−1) where Di and Di−1 are the two previous displacements, ti and ti−1 are the two previous detection times, r is the time at which output was requested, and Dr is the current displacement. The above operation may be executed quickly because of its simplicity, and there is no delay caused by averaging as compared with the case where past data over a longer time span is used.

In various preferred embodiments of the present invention, the operation unit may derive the displacement at time r+τ as the current displacement, where τ is the operation delay in the operation unit. This enables the influence of the operation delay to be reduced to substantially zero. As far as the external servo system or the like is concerned, displacement is requested at time r and received at time r+τ, with this configuration enabling receipt of data that is extremely close to the actual displacement at time r+τ.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram of a linear sensor and the vicinity thereof according to a preferred embodiment of the present invention.

FIG. 2 is a block diagram of constituent elements of a linear sensor from a coil array to a signal processor according to a preferred embodiment of the present invention.

FIG. 3 is a block diagram of an operation unit of a linear sensor according to a preferred embodiment of the present invention.

FIG. 4 is a view of extrapolation of a position signal in a linear sensor according to a preferred embodiment of the present invention.

### DETAILED DESCRIPTION OF THE PREFERRED EMBODIMENTS

Hereinafter, preferred embodiments for carrying out the present invention will be described. The scope of the present invention should be construed in view of the claims together with the description of preferred embodiments below and well known techniques in this field according to the understanding of a person skilled in the art.

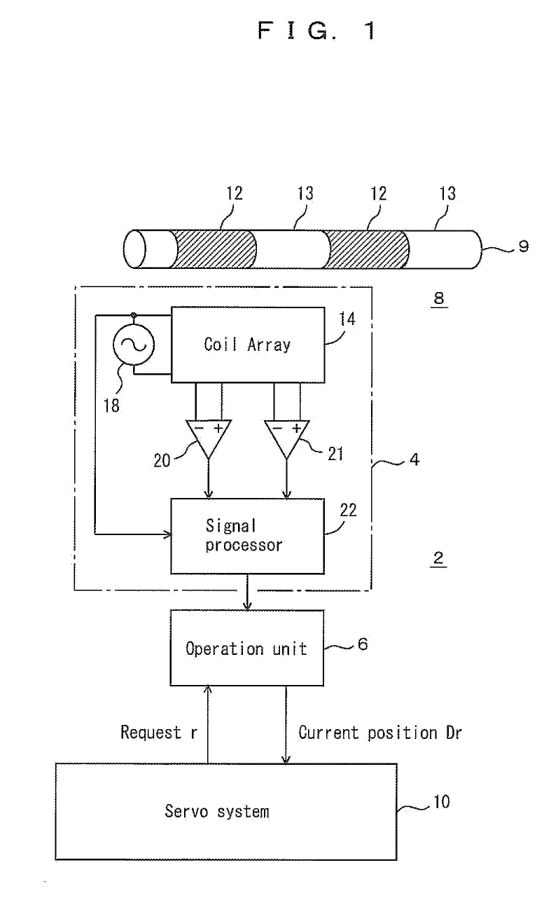

A linear sensor 2 according to preferred embodiments of the present invention is shown in FIG. 1 to FIG. 4. The linear sensor 2 preferably includes a linear sensor main body 4 and an operation unit 6, and detects displacement based on an external magnetic mark 8. A servo system 10 preferably includes a drive for a machine tool head, a drive for workpieces, an actuator for a transfer device, an actuator for an adsorption type transport device, a travel controller for a transport vehicle, or the like. The servo system 10 requests the linear sensor 2 for a current position at time r, receives a current position Dr at time r+τ because of delay τ, and performs position control, velocity control, or the like. The servo system 10 compares the current position with a target position every internal control period, and generates a velocity instruction or the like so as to eliminate positional error. Accordingly, time r at which the current position is requested is determined at the convenience of the servo system 10, and is not determined at the convenience of the linear sensor 2.

The magnetic mark 8, herein, includes marks with non-magnetism 12 and marks with magnetism 13 that are arranged alternately in a longitudinal direction along a shaft 9, and is configured such that the displacement of the shaft 9 is detected. However marks may be disposed around the circumference of a turntable or the like, or marks may be disposed along a travel rail or the like. The linear sensor main body 4 is provided with a coil array 14 and a primary AC power supply 18, with an output voltage waveform of the AC power supply being represented by sin ωt. Four signals, for example, are taken from the coil array 14, two signals of which are input to an operational amplifier 20, and the remaining two signals of which are input to an operational amplifier 21. Displacement based on the marks is derived by signal processing the output signals from the operational amplifiers 20 and 21 in a signal processor 22.

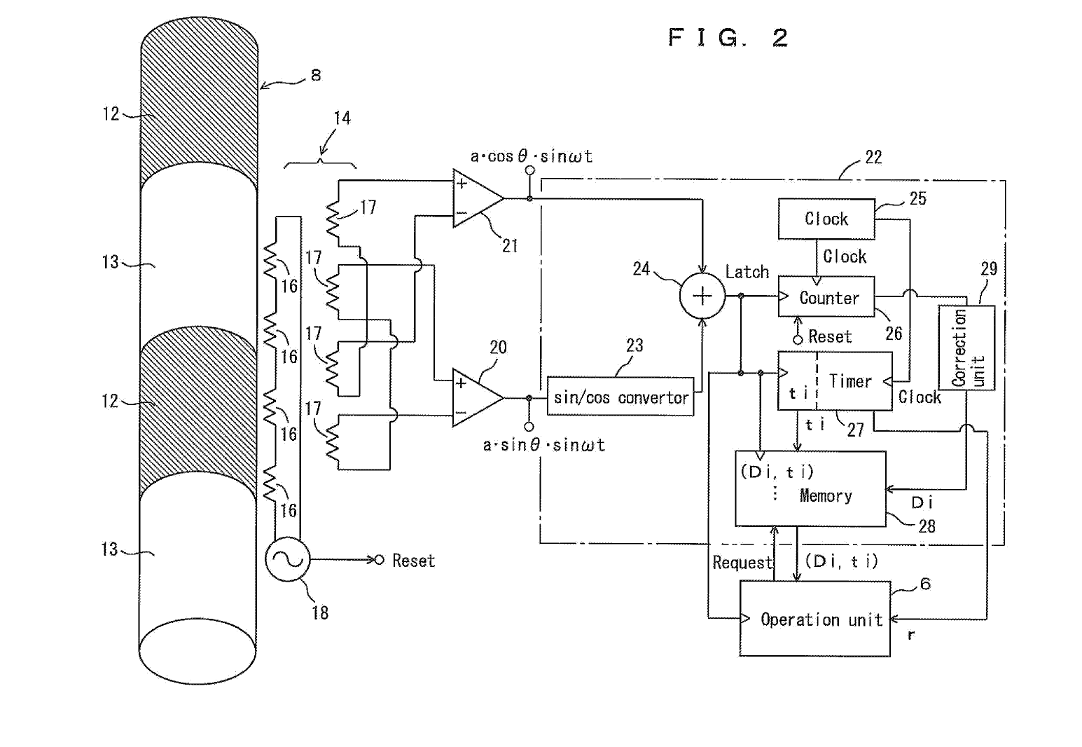

A configuration of the signal processor 22 is shown in FIG. 2. In the coil array 14, four primary coils 16, for example, are connected in series, and the AC power supply 18 inputs an alternating current whose frequency is about 10 kHz to about 20 kHz, for example. Also, because the timing at which the output of the AC power supply 18 will be 0, that is, the timing at which ωt=nπ (n being a natural number) is important to the signal processor 22, a reset signal is output at ωt=nπ. Four secondary coils 17, for example, are disposed in parallel with the primary coils 16, and the result of an induced electromotive force produced by the current flowing through the primary coils 16 being modulated by the marks 12 and 13 is taken as a signal and input to the operational amplifiers 20 and 21. An a·sin θ·sin ωt signal, for example, is obtained from the operational amplifier 20, and an a·cos θ·sin ωt signal is obtained from the operational amplifier 21. Here the primary coils 16 and the secondary coils 17 preferably are separate coils but may be the same coils, as shown in JP 2009-2660A.

A converter 23 converts the a·sin θ·sin ωt signal into an a·sin θ·cos ωt signal. For example, the converter 23, which is constituted by a delay circuit including a memory, delays the signal by a quarter period in relation to sin ωt and furthermore reverses the sign. The present preferred embodiment is not limited to such a technique, and the signal of the operational amplifier 20 may be multiplied by cotωt. An adder 24 adds the a·cos θ·sin ωt signal and the a·sin θ·cos ωt signal, and outputs an a·sin(ωt+θ) signal using the additional theorem. The signal a·sin(ωt+θ) may be replaced by a·sin(ωt·θ). A clock circuit 25 generates clock signals, a counter 26 counts the clock signals and resets the count value in response to a reset signal from the AC power supply 18. The counter is then latched at the point in time that the signal from the adder 24 is 0. Because the reset signal is generated at sin ωt=0 and a latch signal is generated at sin(ωt+θ)=0, the time lag therebetween represents θ, with θ being the displacement based on the marks. As described above, displacement may be detected once or twice, for example, during one period of the AC signal.

A timer 27 derives the time by counting the clocks from the clock circuit 25, and latches the time of an output buffer in the timer 27 in response to a latch signal from the adder 24. The displacement θ is data produced every pairing of the marks 12 and 13, with θ being corrected by the position (offset) of the marks by a correction unit 29 to derive a displacement Di that is independent of the marks. A memory 28 stores the displacement Di together with time ti at which the ith θ was detected.

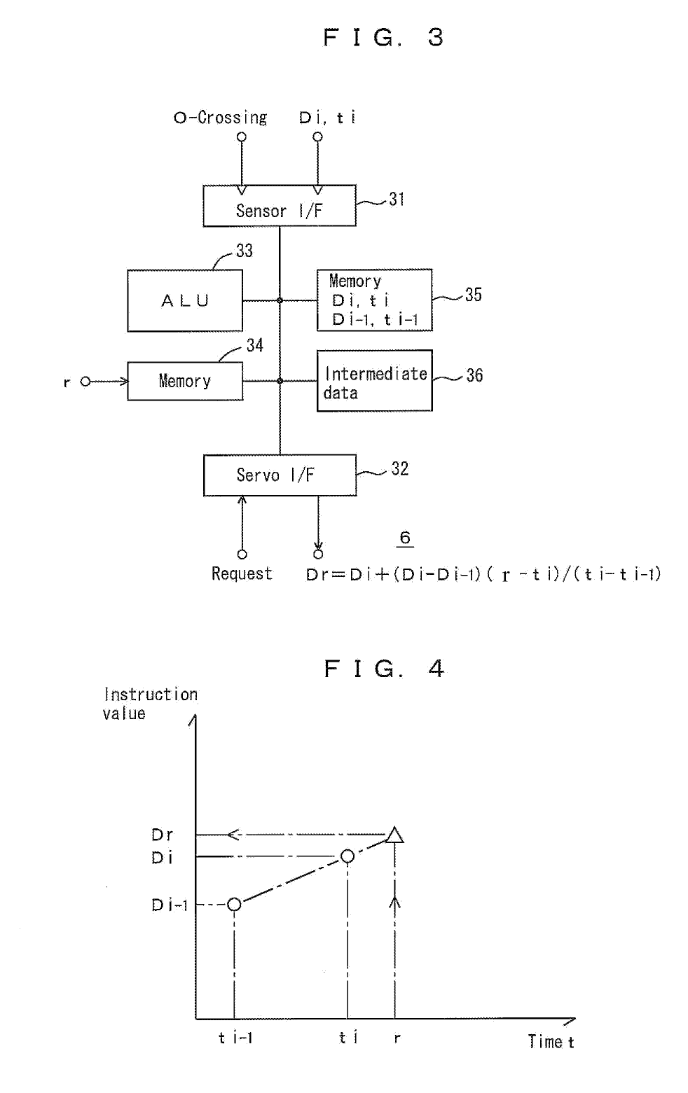

A configuration of the operation unit 6 is shown in FIG. 3. A sensor interface 31 is an interface with the linear sensor main body 4, and a servo interface 32 is an interface with the servo system. An arithmetic logic unit 33 is provided, as is a memory 34 that stores time r at which the displacement output request is received from the servo system. A memory 35 stores at least the two previous pairs of displacement/time data (Di, ti) and (Di−1, ti−1). A memory 36 stores intermediate data required in calculating the current position, and specifically stores (Di−Di−1)/(ti−ti−1).

Assume that a request for output of displacement has been made to the servo interface 32 by the servo system. The memory 34 constantly receives the current time r from the timer of the linear sensor main body, and latches the current time r with a signal from the servo interface 32. The sensor interface 31 receives the pairing of the latest displacement and detection time thereof (Di, ti) from the memory of the linear sensor main body in response to a latch signal (zero-crossing signal) from the adder of the linear sensor main body, and stores the received data in the memory 35. The memory 35 preferably is a ring memory that stores two sets of data, for example, and replaces old data with new data whenever a zero crossing occurs. The memory 36 stores the intermediate data derived by the arithmetic logic unit 33 from the data in the memory 35.

The arithmetic logic unit 33 derives displacement Dr at time r using the equation Dr=Di+(Di−Di−1)(r−ti)/(ti−ti−1) and outputs displacement Dr from the servo interface 32. The arithmetic logic unit 33 thus calculates Dr when the servo system requests the current displacement, and responds at delay time τ. Although the data required in the operation may be acquired from the linear sensor main body each time, in the present preferred embodiment, this data is stored in advance in the memories 35 and 36, shortening the processing time. In particular, (Di−Di−1)/(ti−ti−1) is stored, accelerating processing.

In the arithmetic logic unit 33, one multiplication and one addition, for example, are required in order to calculate the current displacement Dr. A slight time delay τ thereby arises. In order to solve this problem, the memory 34 stores r+τ instead of the actual time r, derives the displacement at time r+τ instead of displacement Dr at time r, and outputs the derived displacement as displacement Dr. Also, the data in the memories 35 and 36 is updated in the idle time after processing the request for displacement from the servo system. The operation unit 6 may be realized by a digital signal processor, a field programmable gate array, a one-chip microprocessor, or the like.

FIG. 4 shows time and instruction value (output current displacement) in the present preferred embodiment. For example, displacement Di−1 preferably is derived at time ti−1 and displacement Di is derived at time ti. When the current displacement Dr is requested at time r between time ti and the next signal, the signals of time ti−1 and time ti are extrapolated and output as displacement Dr. In the case of addressing the problem of the operation delay in the operation unit 6 as mentioned above, the displacement at time r+τ instead of the current time r is output because time τ which is equivalent to the operation delay is substantially constant.

In the present preferred embodiment, the two previous displacements and times are extrapolated, and the current displacement is derived. Alternatively the three previous displacements and times, for example, may be stored, and the current displacement may be extrapolated with a quadratic curve. For example, the following processing is performed in order to estimate the current displacement with a quadratic curve from displacements Di, Di−1 and Di−2 and times ti, ti−1 and ti−2. Acceleration a is determined by (Di−Di−1)/(ti−ti−1)−(Di−1-Di−2)/(ti−1−ti−2). Change h in displacement based on acceleration is defined by h=a/2·(r−ti)². Correction h based on acceleration is added to an estimated value of the current displacement extrapolated by a linear function as described above.

In the present preferred embodiment, a linear sensor preferably including a combination of a magnetic mark and coils was described. However, alternatively the phase difference between the phase of reflected light and the phase on the primary side may be detected, using a laser signal obtained by modulating the light intensity with an alternating current as the primary-side signal, for example. Also, an ultrasonic wave signal may be modulated by a sin θwave, and the phase difference between the ultrasonic wave signal on the primary side and the ultrasonic wave signal of a reflected wave may be detected.

The following advantageous effects are obtained with the present preferred embodiment.

The current displacement is output at the point in time that an external system such as a servo system requests output, without delay caused by the input signal period of the displacement sensor.

The current displacement is quickly derived with a very few operations when derived by a linear operation.

The influence of the operation delay may be easily corrected by replacing time r with time r+τ when delay τ of the operation unit is corrected.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-4. (canceled)

5. A displacement sensor that detects displacement using a phase difference between an input signal waveform and an output signal waveform, in order to output, in response to a request from a servo system to generate an instruction to eliminate error between a current position and a target position by comparing a current position and a target position every control period, the current position to the servo system, the displacement sensor comprising:
a timer that outputs a detection time when the sensor detects a displacement;
a memory that stores at least two previous detected displacements together with detection times thereof; and
an operation unit that extrapolates, when output is requested from the servo system, the at least two previous displacements to a current displacement, based on the at least two previous displacements and the detection times and a time at which output was requested, and outputting the current displacement; wherein
the memory further stores (Di−Di−1)/(ti−ti−1); and
the operation unit derives a displacement at time r+τ as a current displacement Dr by Dr=Di+(r+τ−ti)×(Di−Di−1)/(ti−ti−1) using a value of (Di−Di−1)/(ti−ti−1) stored in the memory, and outputs the current displacement Dr to the servo system as the current position, where Di and Di−1 are the two previous displacements, ti and ti−1 are the two previous detection times, r is the time at which output was requested, Dr is the current displacement, and τ is an operation delay in the operation unit.

6. A displacement detection method to detect displacement with a displacement sensor, using a phase difference between an input signal waveform and an output signal waveform, in order to output, in response to a request from a servo system to generate an instruction to eliminate error between a current position and a target position by comparing a current position and a target position every control period, the current position to the servo system, the method comprising the steps of:
deriving a detection time using a timer when the displacement sensor detects a displacement;
storing at least two previous detected displacements in a memory together with detection times thereof;
extrapolating, when output is requested from the servo system, the at least two previous displacements to a current displacement, based on the at least two previous displacements and detection times and a time at which output was requested, and outputting the current displacement, using an operation unit;
storing in the memory (Di−Di−1)/(ti−ti−1); and
the operation unit deriving a displacement at time r+τ as a current displacement Dr by Dr=Di+(r+τ−ti)×(Di−Di−1)/(ti−ti−1) using the value of (Di−Di−1)/(ti−ti−1) stored in the storage, and outputting the current displacement Dr to the servo system as the current position, where Di and Di−1 are the two previous displacements, ti and ti−1 are the two previous detection times, r is the time at which output was requested, Dr is the current displacement, and τ is an operation delay in the operation unit.
